(19) United States
(12) Patent Application Publication
(10) Pub. No.: US 2011/0233496 A1
(43) Pub. Date: Sep. 29, 2011

(54) MODULAR FENCE

(75) Inventor: Patrick C. Caruso, St. Pau, MN (US)

(73) Assignee: Premier Fence, Inc., St. Paul, MN (US)

(21) Appl. No.: 13/073,148

(22) Filed: Mar. 28, 2011

Related U.S. Application Data
(60) Provisional application No. 61/318,361, filed on Mar. 28, 2010.

(51) Int. Cl. E04H 17/16; E04H 17/20; B23P 19/00

(52) U.S. Cl. 256/24; 29/700

(57) ABSTRACT

A modular fence panel comprising: vertical supports, horizontal stringers, interior panels, and fasteners. These panels feature the ability to ship with little wasted volume whether they are shipped fully assembled or as a ready to assemble kit. In some embodiments, the vertical supports are approximately the same thickness as the thickness of the horizontal stringers.

### CROSS REFERENCE TO RELATED APPLICATION

The present application claims the benefit of, and incorporates by reference hereto, United States Provisional Application No. 61/318,361 of the same title, filed Mar. 28, 2010.

### FIELD OF THE INVENTION

This invention relates generally to the field of fences and more specifically to modular fences.

### BACKGROUND OF THE INVENTION

Wood fences have traditionally been built one board at a time at the site of the fence. The vertical 4 inch by 4 inch posts are set in the ground at any desired distance apart. Horizontal stringers are cut to length according to the spacing of the posts being worked on. They are then nailed to the face of the posts or between the posts. Typically, lumber with nominal dimensions of 1 inch by 4 inches is used when the stringers are nailed on the face of the posts. Boards are nailed or screwed to the stringers. These boards may be vertical such as in a picket fence or at various angles such as in a lattice design. Space between the boards may be large or nonexistent as in over lapped or tongue and groove constructions.

When the stringers are nailed between the posts, 2 inch by 4 inch lumber is used with the 4 inch (nominal) dimension in the lateral direction. Additional 2 by 4's may be nailed to the posts between the stringers. Wood strips are added to the top of the bottom stringer and the bottom of the top stringer to provide a surface to which boards spanning the space between the stringers may be nailed. As in the case of the surface nailed stringers, the boards which span the space between the stringers may have large or small spaces or no space between them. The boards may be vertical or at an angle other than 90 degrees relative to the horizontal stringers. Additional nailing strips are sometimes used on the vertical boards fastened to the posts.

Instead of cutting each board to length as needed on site, there have been some examples of premade panels. One common example of a premade panel which nails or screws to the face of the posts is a stockade fence panel. Boards approximately 2 inches wide having a point at one end are nailed to two or more stringers. The panel is placed against the face of two posts, leveled, and nailed or screwed in place.

Premade panels that go between the posts are made in a way similar to the panels fabricated on site. A frame of 2 by 4's is made with the 4 inch dimension in the lateral direction. Nailing strips are added to the interior surfaces of the 2 by 4's. Boards are nailed to the nailing strips according to the design pattern.

The premade panels that fasten between the vertical posts have several problems. Each panel is approximately 3.5 to 4 inches thick. Shipping these premade panels includes a large amount of empty space. Adjusting the length of these panels is difficult. The frame must be disassembled and boards fastened to the nailing strips on the ends need to be removed. Some boards fastened to the nailing strips on the stringers must be removed to cut the stringers and the end board or boards individually. The panel must then be reassembled. This is time consuming and depending on the construction methods may damage some of the component pieces.

Thus, a need exists for a modular fence that eliminates, or substantially eliminates the problems of the prior art.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a panel fence.

FIG. 2 is an illustration of a panel fence installed between two posts.

FIG. 3 shows the components of the fence panel of FIG. 2.

FIG. 4 illustrates several designs for restraining the interior panels.

FIG. 5 illustrates several cross section designs for interior panels.

FIG. 6 illustrates different designs for the vertical supports.

FIG. 7 illustrates using horizontal stringers between the top and bottom stringers, and attachment to the post.

FIG. 8 illustrates several designs of interior panels, and attachment to the posts.

FIG. 9 illustrates various panels configurations.

FIG. 10 illustrates one embodiment of a modular system.

FIG. 11 illustrates gates made from modular fence components.

FIG. 12 illustrates different post constructions and methods of attaching to posts.

### SUMMARY OF THE INVENTION

One object of some embodiments of the invention is to provide a panelized fence with fully assembled panels that can be shipped in a compact form.

Another object of some embodiments of the invention is to provide a panelized fence where the panel components are provided as a kit, boxed with instructions and fasteners for quick assembly.

Another object of some embodiments of the invention is to provide a panelized fence where the panel can be easily shortened, or modified for a gate system built with simple add on vertical components.

A further object of some embodiments of the invention is to provide a panelized fence where the panel interior vertical components are constrained vertically yet allowed to expand laterally with changing environmental conditions.

Yet another object of some embodiments of the invention is to provide a modular fence where design features are easily customized and interchangeable.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a modular fence panel comprising: vertical supports, horizontal stringers, interior panels, and fasteners. These panels feature the ability to ship with little wasted volume whether they are shipped fully assembled or as a ready to assemble kit. In some embodiments, the vertical supports are approximately the same thickness as the thickness of the horizontal stringers.

In some embodiments, the surfaces where the stringers connect to the vertical supports are parallel to each other and perpendicular to the longitudinal direction of the fence. This allows for easy modification to the length of the fence panel. The fasteners attaching one of the vertical supports are removed, and then using a cutting device such as a saw, a straight cut of the stringers and interior panels is all the alteration required to the components to shorten the length of the panel. Reattaching the vertical support completes the shortening process.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

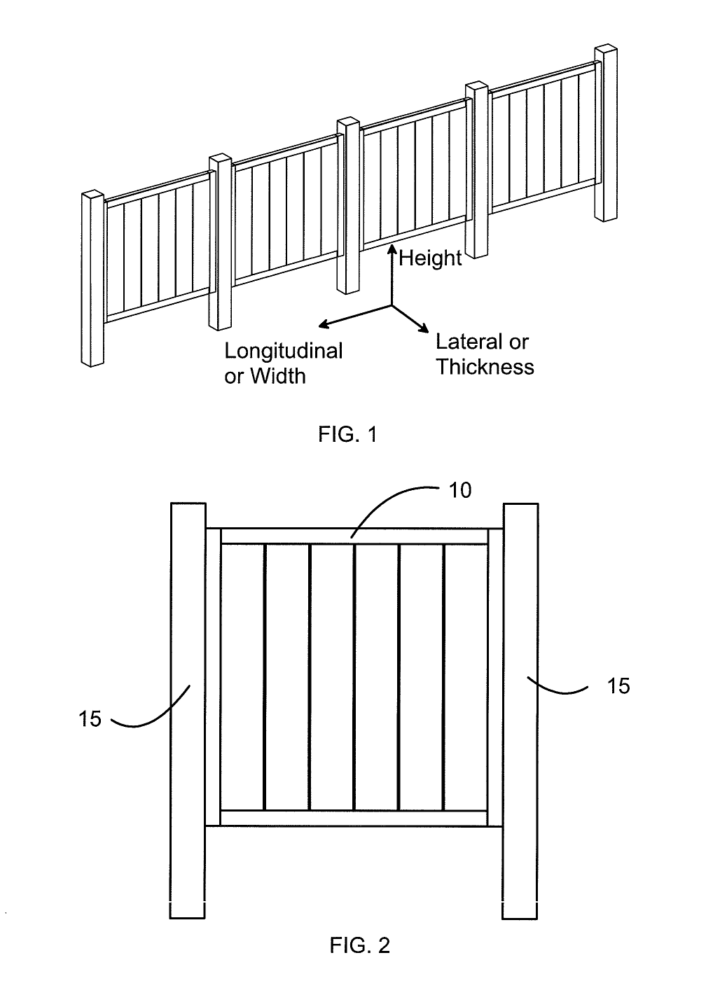

Longitudinal direction or axis is the direction of the line of the fence as shown in FIG. 1. This direction is also referred to as the width of a component or panel. Vertical direction or axis is the direction perpendicular to the ground as shown in FIG. 1. This direction is also referred to as the height of a component or panel. Lateral direction or axis is the direction perpendicular to the surface of the fence panel as shown in FIG. 1. This direction is also referred to as thickness or depth of a component or panel.

References to these directions or axis are to be applied to uninstalled fence components according to the direction of the component when installed in the fence unless otherwise noted.

In this application, use of the reference numbers on the following list implies that the corresponding component is a generalized component which may incorporate any or all of the features described for various embodiments of that component: panel (10), post (15), vertical support (20), bottom horizontal stringer (30), top stringer (40), intermediate stringer (335), internal panel (50), fastener (60), support component (740).

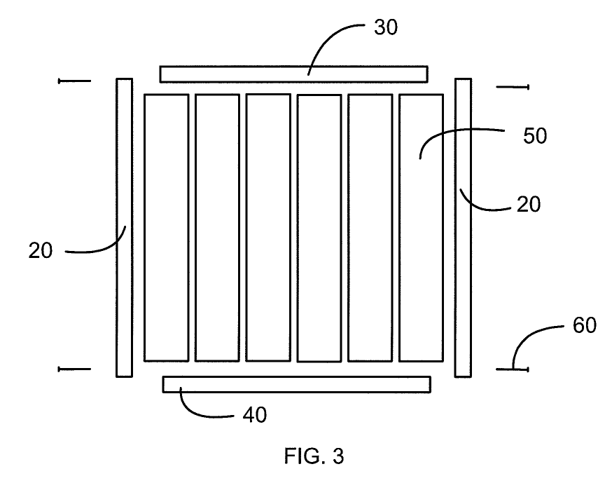

Referring now to the drawings in greater detail, FIG. 2 shows an embodiment of the invention. A fence panel (10) is mounted in place between two posts (15). FIG. 3 shows the components of the fence panel (10). The horizontal stringers (30) and (40) constrain the vertical and lateral movement of the interior panels (50). The vertical supports (20) constrain the movement of the horizontal stringers. The vertical supports (20) removably attach to the horizontal stringers on coplanar surfaces perpendicular to the longitudinal axis by use of fasteners (60).

In some embodiments the fence material is plastic such as polyvinyl chloride, polypropylene, polyester, polyethylene, or ABS. In some embodiments, the material is a composite made of a plastic and wood. In some embodiments, the material is wood. In some embodiments the material is cedar. In some embodiments, the material is kiln dried cedar.

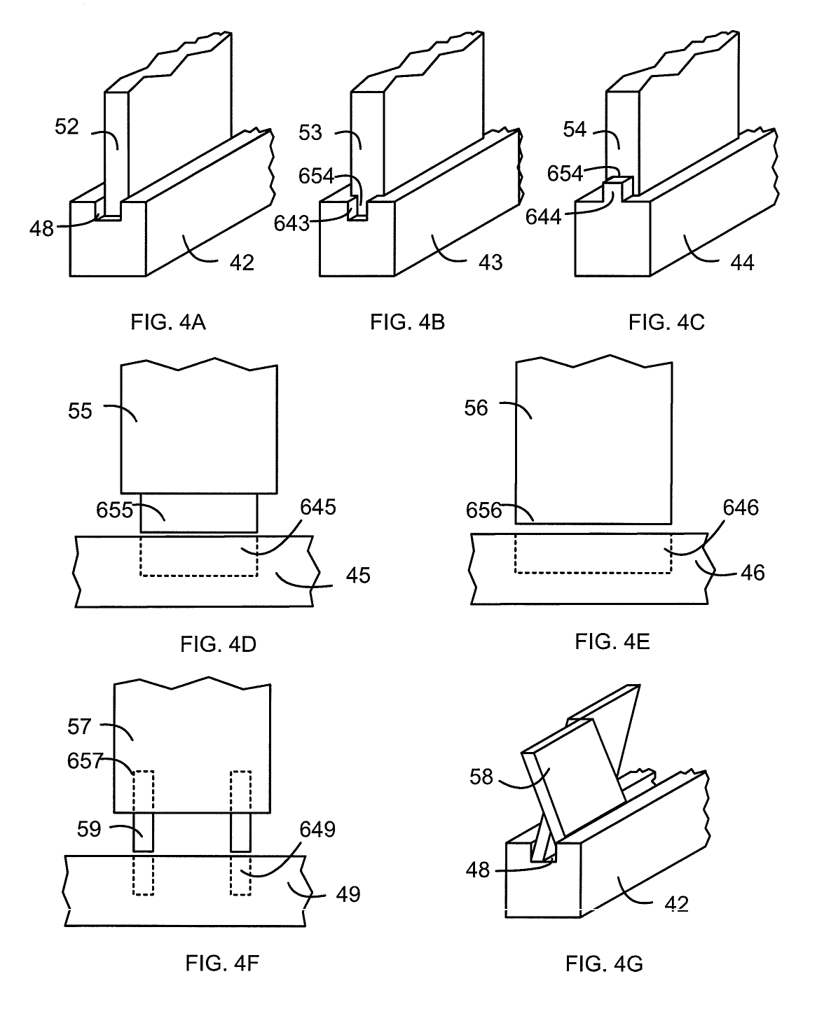

In some embodiments, the horizontal stringers (30) and (40) constrain the interior panels (50) utilizing the shape of horizontal stringers and interior panels. FIG. 4 illustrates a number of possible shapes but does not necessarily limit the invention to these embodiments shown. In some embodiments, the interior panels, FIG. 4A (52) are fabricated with flat ends that fit within a groove (48) in the horizontal stringer (42). In some embodiments, the interior panels FIG. 4B (53) and horizontal stringers (43) are fabricated with a tongue and groove construction. FIG. 4B illustrates such construction with tongue (654) on the interior panel (54) and the groove (643) on the horizontal stringer (43). FIG. 4C illustrates the tongue and groove construction with the groove (654) in the interior panel (54) and the tongue (644) on the horizontal stringer (44). In some embodiments, the interior panels FIG. 4D (55) and horizontal stringers (45) are fabricated with a mortise (645) and tenon (655) construction. In some embodiments, the interior panels FIG. 4E (56) fit into pockets (646) in the horizontal stringers (46). In some embodiments, the interior panels, FIG. 4F (57) and the horizontal stringers (47) are joined together with pins or dowels (59) in holes (649) and (657). In some embodiments, the interior panels, FIG. 4G (58), form a lattice which is constrained in a groove (48) in the horizontal stringers (42).

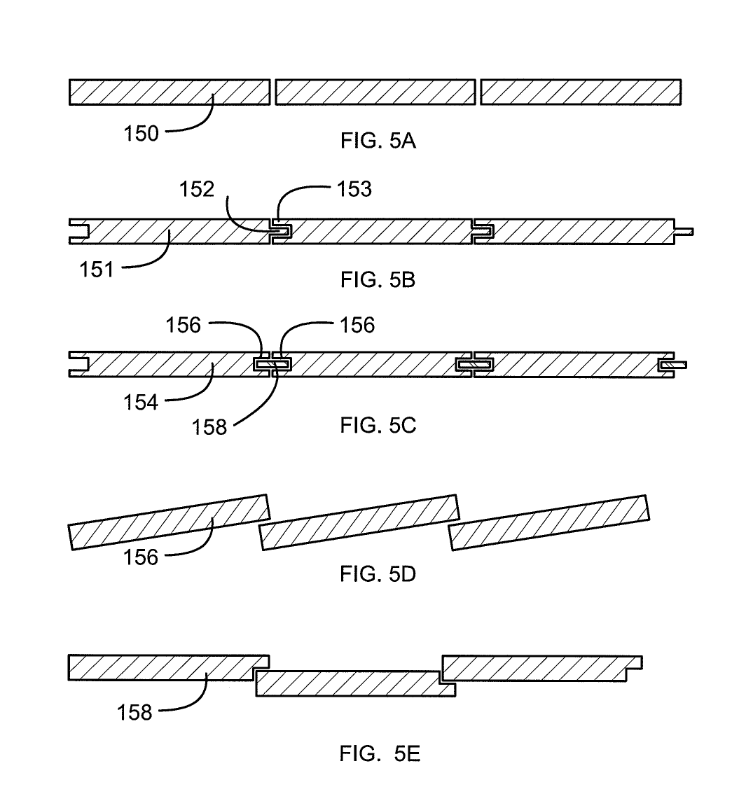

The interior panels (50) may have a variety of cross sections. FIG. 5 shows several illustrative, but not limiting, embodiments. In FIG. 5A, the interior panels (150) have a rectangular cross section. In some embodiments, the space between the interior panels (150) approximately zero. In some embodiments, the interior panels (150) have space between them in the range of approximately zero to 12 inches. In FIG. 5B, the interior panels (151) have a tongue (152) and groove (153) construction. In FIG. 5C, the interior panels (154) have a groove (156) on each edge of the interior panel and with a loose tenon (158) in the space created by the grooves. FIG. 5D and 5E, show illustrations of over lapping interior panels (156) and offset interior panels (158).

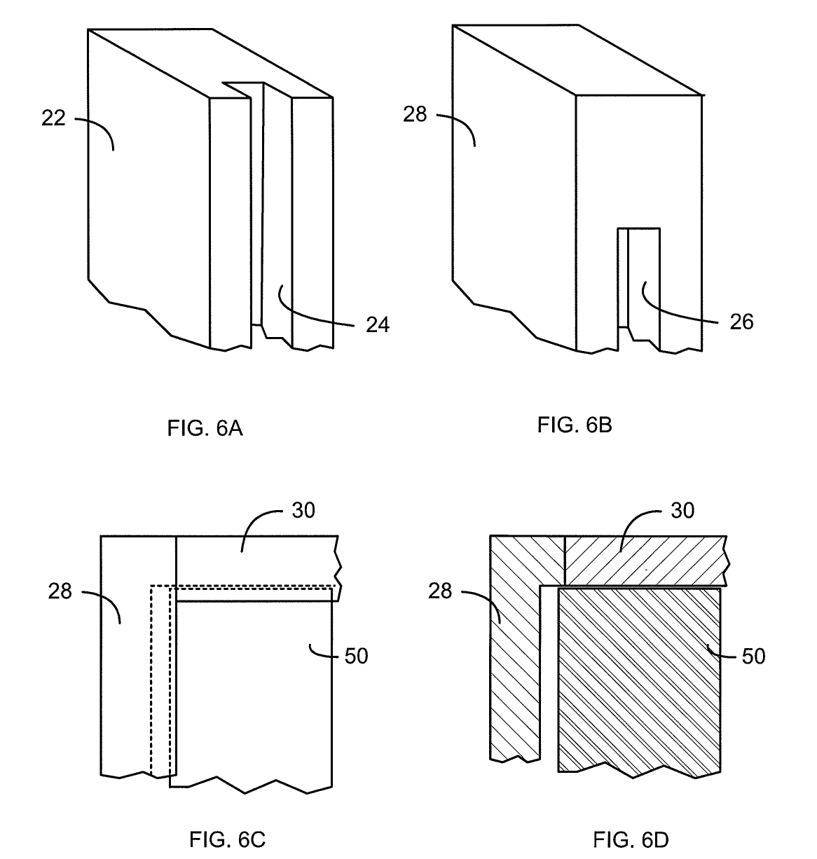

The vertical end supports (20) in some embodiments are solid rectangular shapes. In some embodiments, the vertical end supports, FIG. 6A (22), have a groove (24) the height of which is at least the height of the interior panels. In some embodiments, the groove (24) extends the full length of the vertical support. In some embodiments, the groove, FIG. 6B (26), does not extend the full length of the support (28), but terminates within the interfaces of the vertical support (28) to the top horizontal stringer (30) and the bottom horizontal stringer (40). The dimension of the groove in the lateral direction is sufficient to allow the edge of an interior panel (50) to enter the groove (24) or (26). In some embodiments, the dimension of the groove (24) or (26) in the longitudinal direction is determined so as to be sufficient to accommodate movement of the interior panels (50) due to environmental conditions such as temperature and humidity. In some of the embodiments, the dimension of the groove (24) or (26) in the longitudinal direction is approximately 0.5 inches.

In some embodiments the thickness of the vertical supports (20) is approximately the same as the thickness of the horizontal stringers (30) and (40). The preferred range of thickness of the vertical supports (20) and horizontal stringers (30) and (40) is between 0.5 inches to 4.0 inches. A more preferred range of thickness of the vertical (20) supports and horizontal stringers (30) and (40) is between 0.75 inches to 2.0 inches. It is preferred that the maximum depth of the interior panel or panels (50), as assembled in the frame of the vertical supports (20) and horizontal stringers (30) and (40), be approximately less than or equal to the maximum thickness of the vertical supports (20) and horizontal stringers (30) and (40).

In some embodiments, the fence panel components (vertical supports (20), horizontal stringers (30) and (40), interior panels (50), and fasteners (60)) are assembled prior to being received by the installer (contractor or property owner or representative). In some embodiments, the components (vertical supports (20), horizontal stringers (30) and (40), interior panels (50), and fasteners (60)) are shipped as an unassembled kit, (also known as a knocked down kit) for assembly by the local distributor or retailer or by the installer (contractor or property owner or representative). In some embodiments, the same components (vertical supports (20), horizontal stringers (30) and (40), interior panels (50), and fasteners (60)) are used in both pre-assembled panels and knocked down kits.

The panel (10) is assembled by placing the internal panels (50) in position relative to the bottom horizontal stringer (40) so as to engage the constraining features on the internal panels (50) and bottom horizontal stringer (40). The top horizontal stringer (30) is set in place on the top of the interior panels (50) so as to engage the constraining features on the internal panels (50) and top horizontal stringer (30). The vertical supports (20) are attached to the horizontal stringers (30) and (40) with the fasteners (60). In some embodiments, one or more screws (60) are used to attach each end of the horizontal stringers (30) and (40) to the vertical supports (20). In some embodiments, other fasteners such as nails or knock-down hardware are used to join the horizontal stringers to the vertical support. Examples of knock-down hardware include but are not limited to cross dowels, cam locks, and Rockler MiniFix connectors.

If a panel (10) needs to be shortened, the horizontal stringers (30) and (40) and internal panels (50) may be cut as a unit or as individual components with a saw in a straight, vertical line. A vertical support (20) is fastened to the shortened horizontal stringers (30) and (40) with fasteners (60) used to assemble the full sized panel (10). The present invention provides a simplified means of varying the length of a panel (10), with little or no de-assembly required.

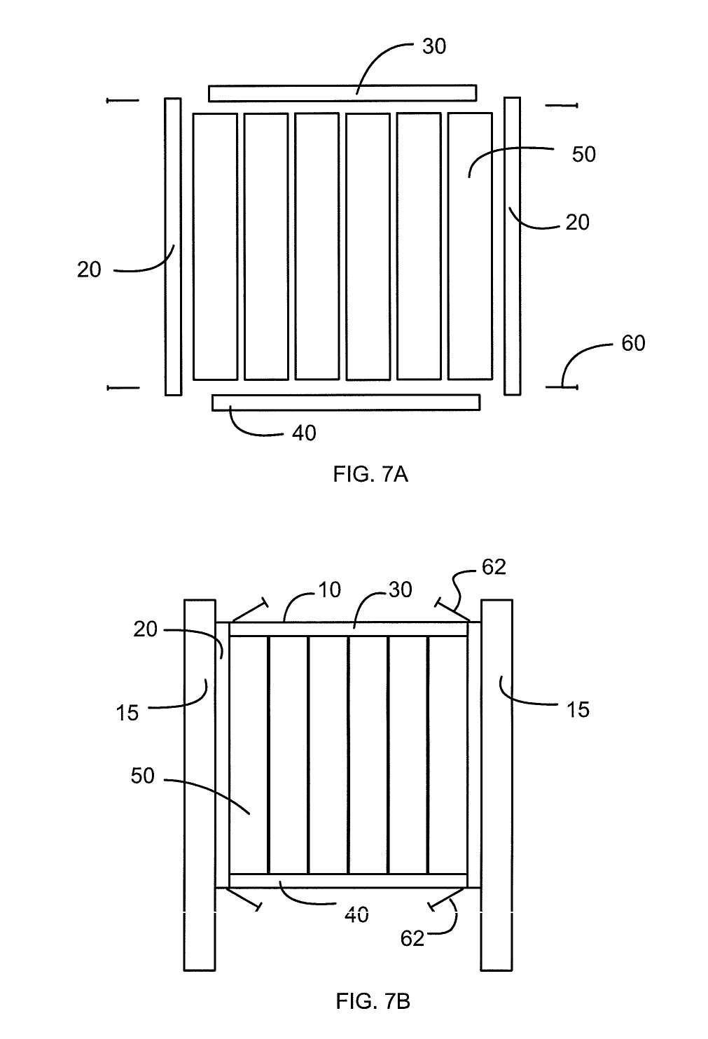

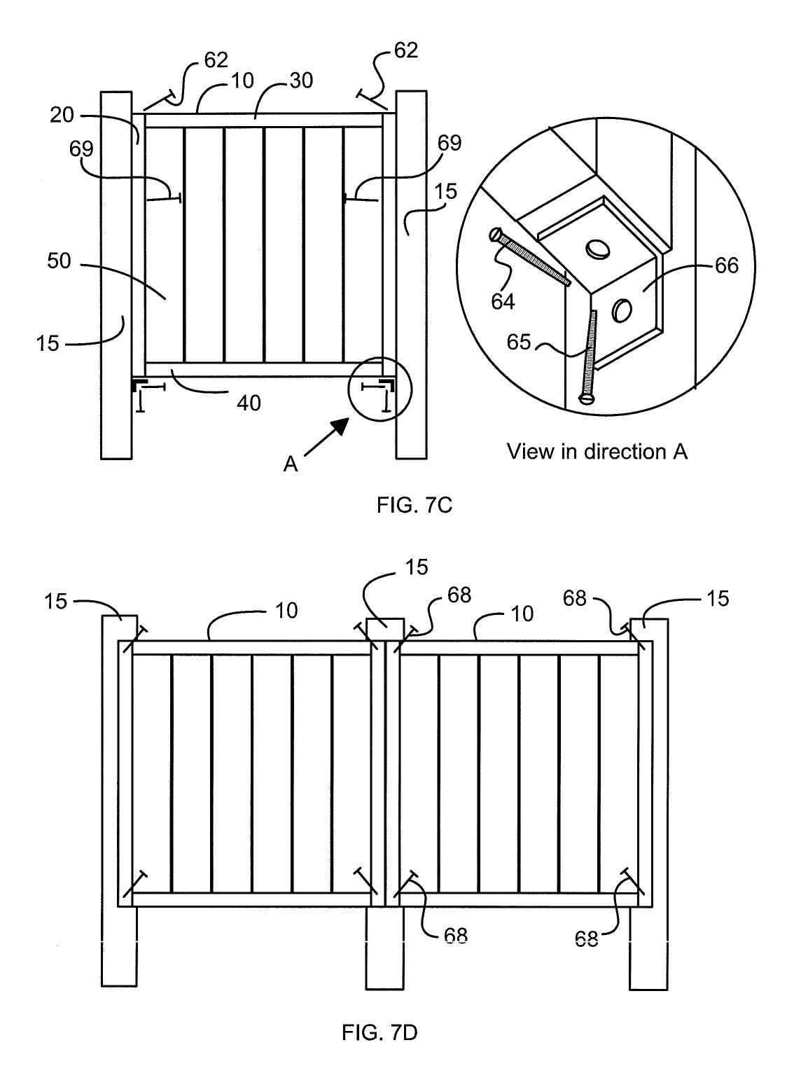

In some embodiments, the assembled panel (10) is attached to the posts (15) by two or more fasteners (62) with at least one at the top and one at the bottom of each of the vertical supports (20) as shown in FIG. 7A. The fasteners (62) may be screws, or nails, or nut and bolts, other fasteners suitable for attaching the panel (10) to the posts (15).

In some embodiments, brackets FIG. 7B (66) are used to support and restrain the movement of the bottom corners of the panel (10). In some embodiments, the brackets (66) may be simple L shaped brackets as shown in FIG. 7C. In other embodiments, the brackets may be more complex incorporating means to restrain the lateral movement of the bottom of the panel (10). Means for restraining in more complex brackets would include extending the material of the bracket up the sides of the panel (10) and a bracket with a pin or feature engaging a hole or matching feature in the panel (10). One bracket (66) is first attached to a post (15) with one or more suitable fasteners (64) such as screws, nails, or nuts and bolts. Then the second bracket (66) is located on a second post (15) at the appropriate height relative to the first bracket (66) (most commonly approximately level but may be a different height than the first bracket) and then attached to the second post (15) with one or more fasteners (64). The assembled panel (10) may then be placed on the brackets (66). In some embodiments, the panel (10) is attached to the bracket (66) with one or more suitable fasteners (65). In some embodiments, additional fasteners are not required.

In some embodiments, the top of the panel (10) is attached to the post (15) with one or more fasteners (62) on each end of the panel (10) near the top of the panel (10). In some embodiments, fasteners (69) attach the panel (10) to the post (15) in the area from the midway point up to near the top of the panel (10). These fasteners (69) may be in addition to the fasteners (62) installed at the top of the panel (10) or in lieu of the fasteners (62) installed at the top of the panel.

To assist in locating the posts (15) precisely, in some embodiments, the assembled panel (10) is attached to the posts (15) prior to one or both of the posts being set in the ground.

In some embodiments, the assembled panels (FIG. 7D (10)) are fastened with suitable fasteners (68) to a lateral surface on each post (15) as opposed to mounting between the posts (15). This embodiment makes assemble of the panels (10) to the posts (15) easier because it allows for more flexibility as to the width of the panels (10).

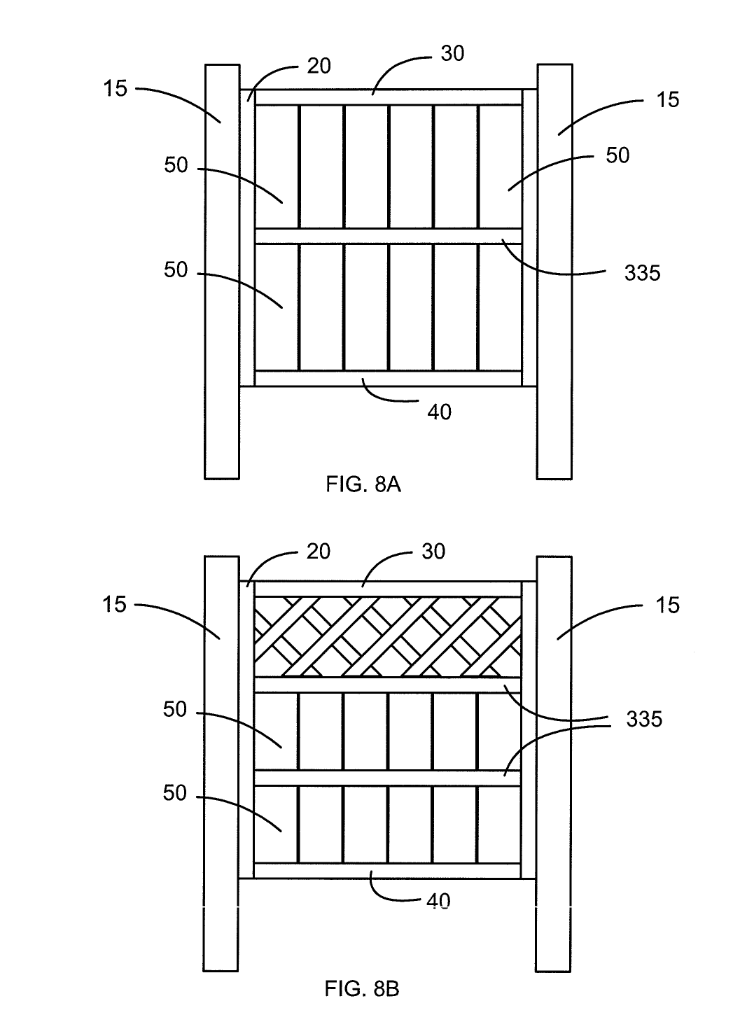

In some embodiments, in addition to a top horizontal stringer (30) and a bottom horizontal stringer (40), there is one or more additional intermediate horizontal stringers (335) as illustrated in FIG. 8A and FIG. 8B. These additional horizontal stringers provide increased design options. These additional horizontal stringers (335) will have features on both the top and bottom surfaces for constraining the internal panels (50) consistent with the constraining features on the top and bottom horizontal stringers (30) and (40).

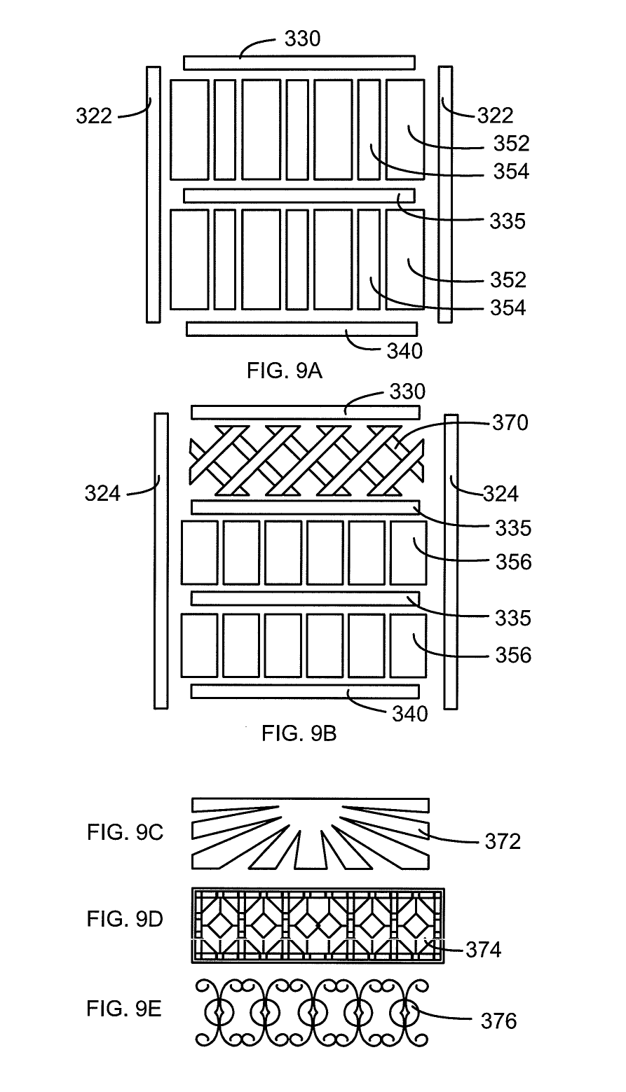

The non-lattice interior panels described thus far have been of sizes such that multiple panels with the same dimensions are used to fill the space between the vertical supports (20). In some embodiments, multiple panels of different widths are used (FIG. 9A (352) and (354)). In some embodiments, the space between the vertical supports (20) and between the horizontal stringers (30) and (40) is filled with one panel. In some embodiments, a single, decorative panel is used. FIG. 9A-9E shows some illustrative, but not limiting examples of decorative interior panels. FIG. 9B illustrates a lattice panel (370) fabricated from multiple crossing strips. FIG. 9C illustrates a radial pattern fabricated by removing material from a single panel (372). FIG. 9D illustrates a plastic sheet as a decorative panel (374). FIG. 9E illustrates a metal fabricated panel (376). While some decorative panels may require unique attachment components, it is preferred that decorative panels be constrained in the same or similar manner used to constrain the other interior panels or in a manner that is compatible with the retaining features in the vertical supports (20) and horizontal stringers (30) and (40).

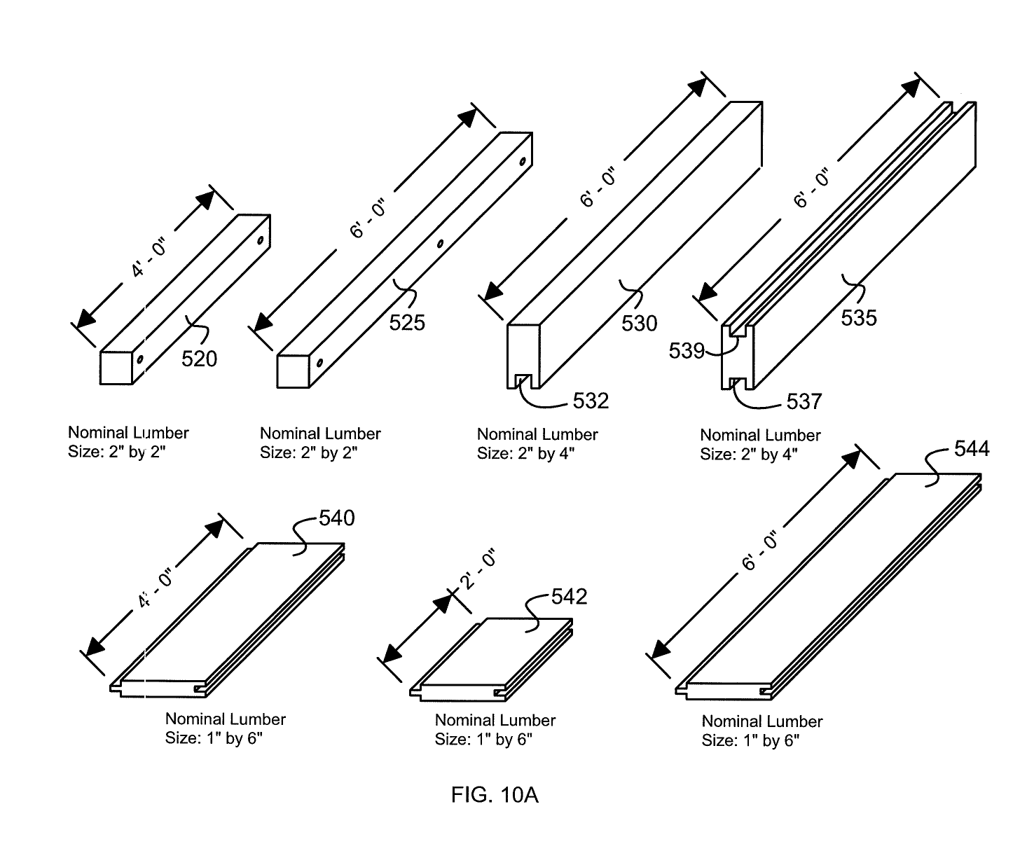

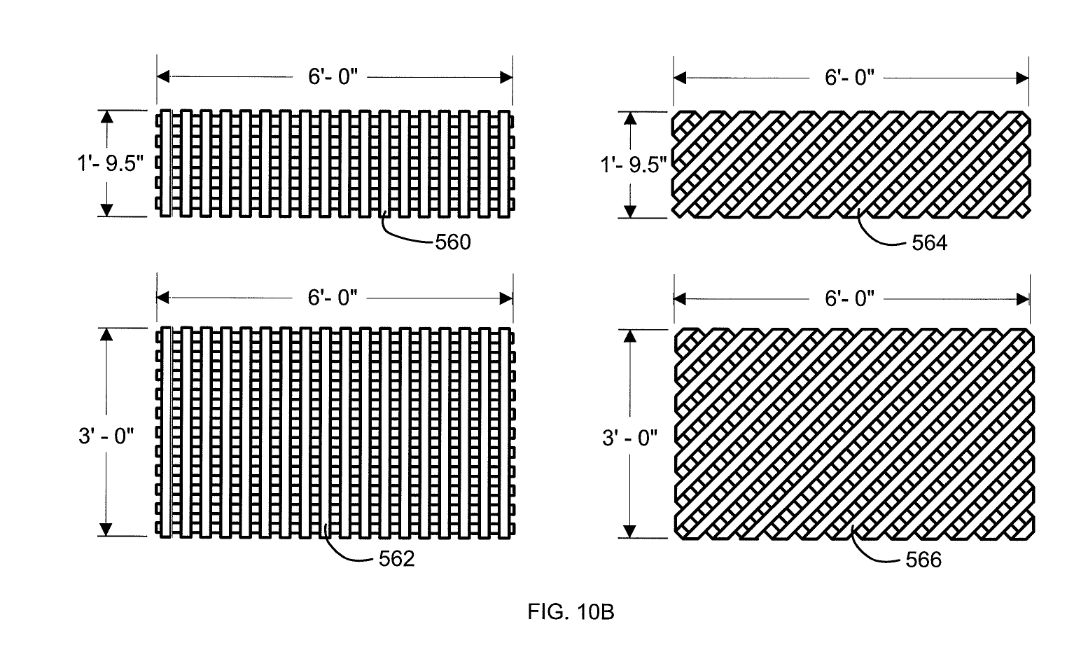

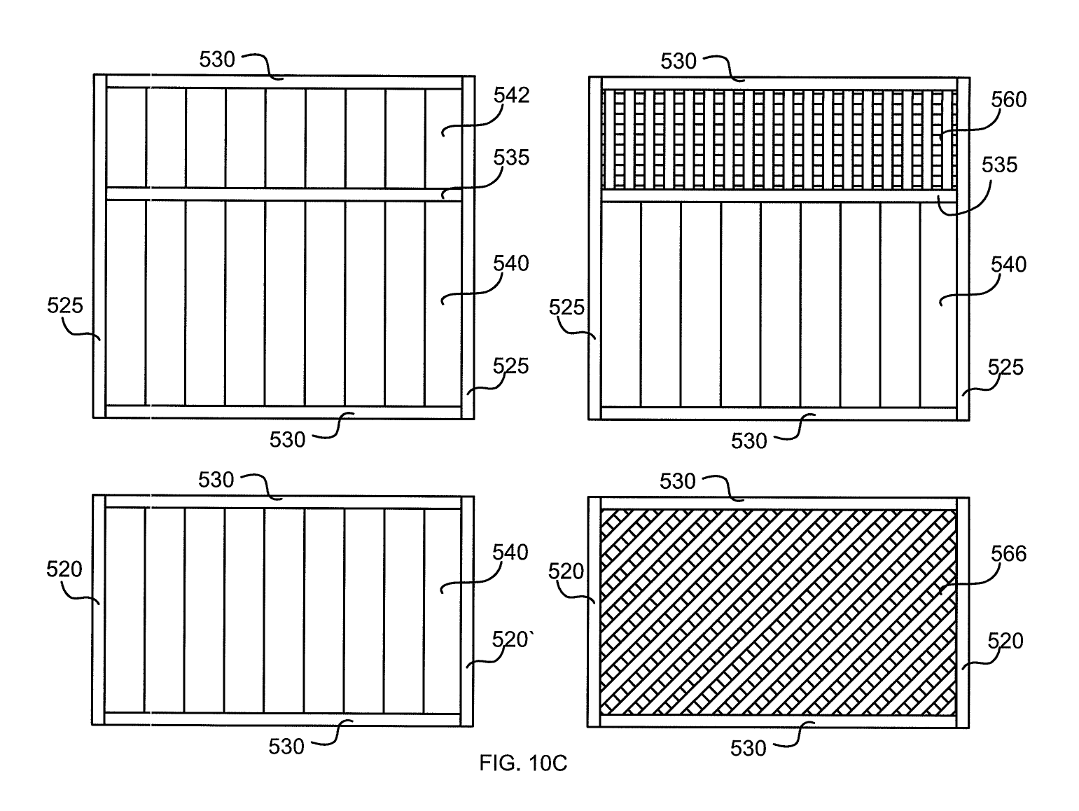

In some embodiments, a set of compatible components are used to make several different panel sizes and designs. Such a set is illustrated in FIG. 10. This is not to be limiting but illustrates one embodiment. The material for this embodiment is kiln dried red cedar, but other materials can be used. The vertical supports (520) and (525) are nominal 2 inch by 2 inch by 4 feet (520) or 6 feet (525). The horizontal stringers (530) and (535) are nominal 2 inch by 4 inch by 6 feet. The top and bottom stringers (530) have a groove (532) on one 2 inch wide side of the board. The stringers (535) which are used between the top and bottom stringers (530) have two grooves (537) and (539) one on each of the 2 inch wide sides of the board. A preferred lateral dimension of the grooves (532), (537), and (539) in the horizontal stringers (530) and (535) ranges from approximately the thickness of the solid interior panels (540), (542), and (544) to 0.5 inches greater than the thickness of the solid interior panels (540), (542), and (544). Solid interior panels (540), (542), and (544) are nominal 1 inch by 6 inch by 2 feet (540), or 4 feet (542), or 6 feet (544). In addition, lattice panels, FIGS. 10 B (560), (562), (564), and (566) are available as part of the set and have a maximum thickness approximately the same thickness as the solid interior panels (540), (542), and (544) +0.25 inches. FIG. 10C illustrates a few of the numerous different panel designs which may be assembled using the above components with the appropriate fasteners.

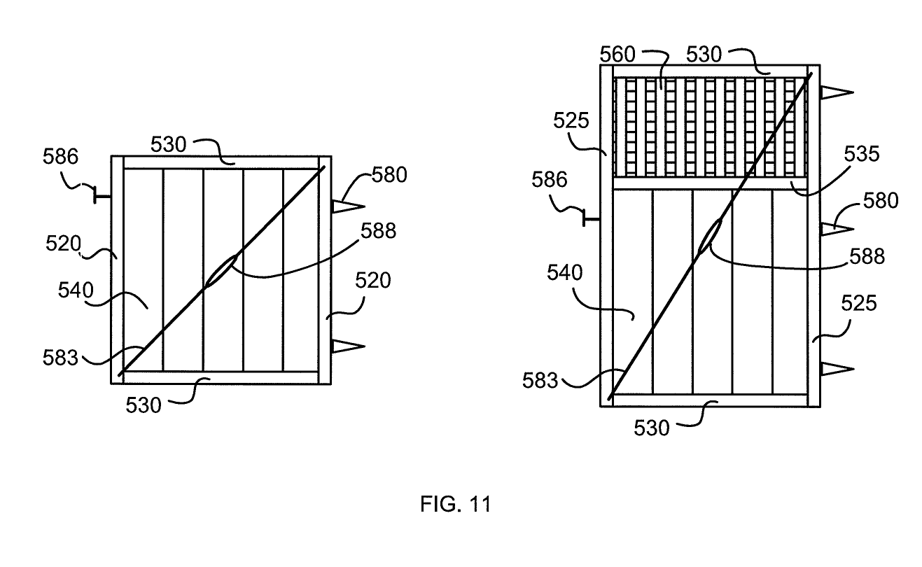

In some embodiments, with the addition of common fence hardware such as hinges (FIG. 11 (580)), latch (586), and diagonal support (583) (frequently incorporating a dimension-adjusting feature such as a turnbuckle (588)), the components of the fence panel may be used to make a gate. To size the gate to the desired opening, the gate may be shortened with a saw in the same manner as when the posts are closer than the length of the panel. In some embodiments, different modular components may be used to make a gate of a different size or design. Two illustrative, but not limiting, examples are shown in FIG. 11.

Posts to which the panels attach may be of a number of different constructions. Some embodiments use solid nominal 4 inch by 4 inch or 6 inch by 6 inch posts of a rot, rust, or decay resistant material such as (but not limited to) pressure treated wood, iron wood, cedar, wood/plastic composite, plastic, or metal such as aluminum or galvanized or otherwise rust-resistant steel. In some embodiments, treatments such as painting or applying a protective coating are used to increase the durability of the post material whether it is naturally resistant to rot, rust, or decay. In some embodiments, the posts are made from solid nominal 4 inch by 4 inch or 6 inch by 6 inch posts of kiln dried cedar.

The posts FIG. 2 (15) provide the means for resisting movement of the fence. The posts (15) may be embedded in a surface such as concrete or the ground, fastened to a surface such as a floor, ceiling, sidewalk, wall, etc., or fastened to bracket or device secured in the ground or on a surface. In some embodiments, the posts (15) rest on the ground or on a surface without being secured to the ground or surface.

In some embodiments, the posts (15) are made of a solid beam of wood or wood/plastic composite. In some embodiments the posts (15) are made of cedar. In some embodiments the posts (15) are made of kiln dried western red cedar. In some embodiments, the posts have cross sectional dimensions that correspond to the dimensioned lumber with the nominal dimensions of 4″ by 4″ or 6″ by 6″.

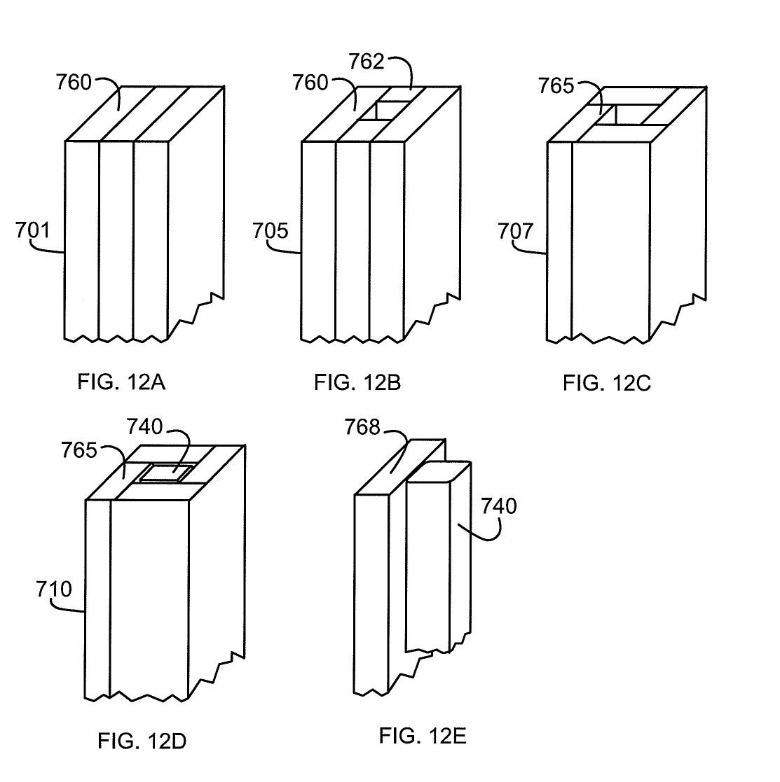

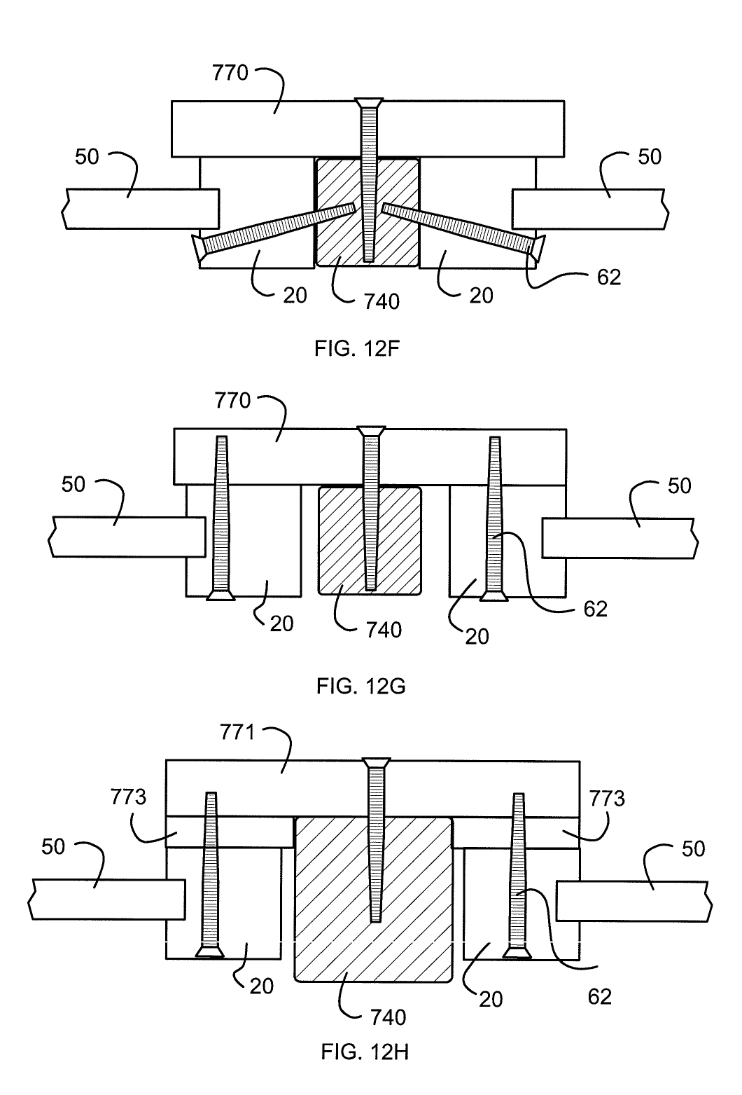

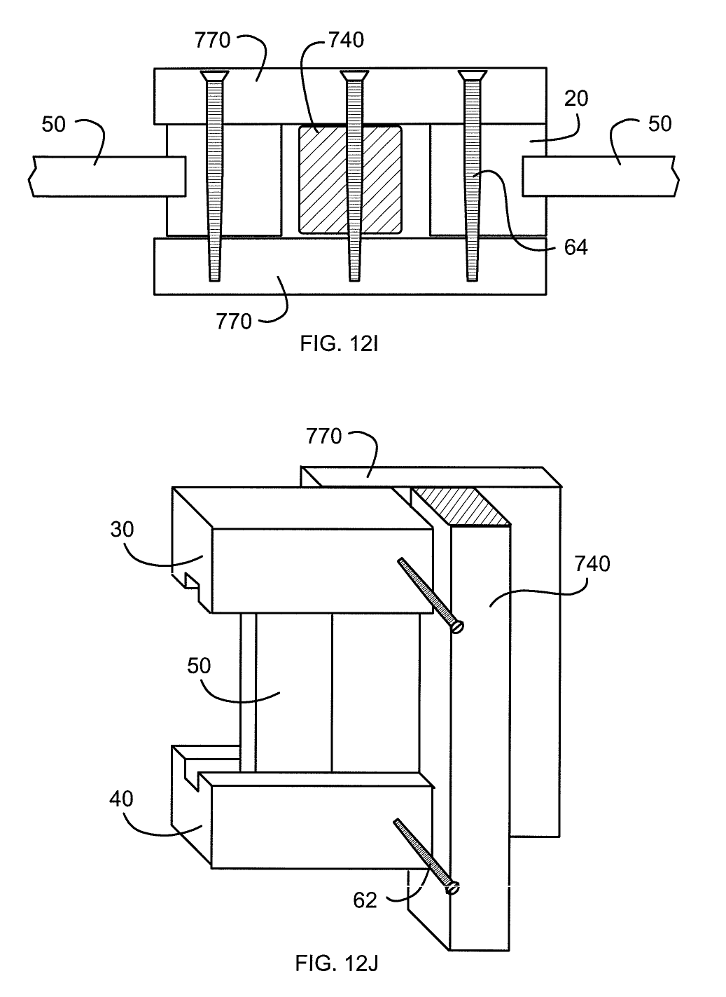

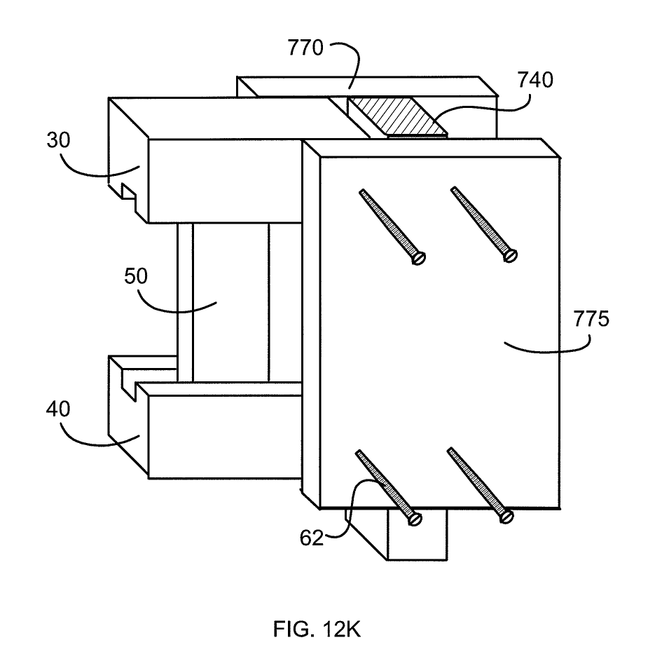

In some embodiments, the posts are fabricated from more than one component. FIG. 12A illustrates a solid post (701) made from multiple parallel components (760). FIG. 12 B illustrates a hollow post (705) made with multiple parallel components (760) and (762). FIG. 12C illustrates a hollow post (707) made with components (765) in a non-parallel arrangement.

In some embodiments, posts FIG. 12D (710) have a support component (740) which provides the primary means for resisting movement of the fence. Additional post components (765) attach to the support component (740) either directly or indirectly through another post component. The support component (740) may be resting on or embedded in a surface such as concrete or the ground, fastened to a surface such as a floor, ceiling, sidewalk, wall, etc., or fastened to another support device such as bracket or fixture secured in the ground or on a surface. In some embodiments, the support component (740) is a solid material such as wood, metal, or plastic. In some embodiments, the support component (740) is a hollow tube of aluminum or steel with a square, rectangular, or circular cross section.

In some embodiments, the support component FIG. 12D (740) is contained within a hollow arrangement of the other post components (765). In some embodiments as illustrated in FIG. 12E, the support component (740) is not contained entirely within attached post components (768).

In some embodiments as illustrated in FIG, 12F, the vertical end support (20) attach directly to the support component (740). In some embodiments as illustrated in FIG. 12G and 12H, the vertical end supports (20) attach to post components (770) other than the support component (740) either directly or through another post component as illustrated in FIG. 12 H (773). In some embodiments, one vertical end support (20) attaches directly to the support component (740) as illustrated in FIG. 12F while the other vertical end support (20) attaches to a post component (770) or (773) as illustrated in FIG. 12 G and FIG. 12H.

In some embodiments as illustrated in FIG. 12I, at least one vertical end support (20) attaches to two post components (770) which are not the support component (740).

In some embodiments as illustrated in FIG. 12J, the top and bottom horizontal stringers (30), (40) and optionally intermediate horizontal stringer(s) (335), but not the vertical end supports (20), are fastened directly to a component of the post (770). The bottom horizontal stringer (40) is fastened at each end to a post component (770). The interior panels (50) are assembled on the bottom horizontal stringer (40). The top stringer (30) or an intermediate stringer (335) is assembled on the top of the interior panels (50) and fastened to the post component (770). Additional interior panels (50) and horizontal stringers (335) or (30) are added per the selected design with the horizontal stringers (335) or (30) being fastened to the component (770) with fasteners (62). An additional component FIG. 12K (775) may be fastened to the horizontal stringers (40), (30), and (335) and optionally to the support component (740).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

1. A modular fence, comprising:
a. a plurality of vertically oriented and horizontally spaced post, secured to the ground;
b. a plurality of modular panels positioned generally between and secured to the posts, the panels comprising:
(i) one or more horizontal rails;
(ii) one or more vertical supports; and
(iii) one or more interior panels oriented between the rails and supports to form the panels.

2. The modular fence of claim 1, wherein the vertical supports are removably attached to the horizontal rails by use of fasteners.

3. The modular fence of claim 1, wherein the interior panels are fabricated with a tongue and groove construction, the tongue being on the interior panel and the groove in the horizontal rail.

4. The modular fence of claim 1, wherein the interior panels and horizontal rails are fabricated with a mortise and tenon connection.

5. The modular fence of claim 2, wherein at least some of the fasteners are pins or dowels.

6. The modular fence of claim 1, wherein the interior panels have a cross-section comprising at least one of; rectangular, tongue-and-groove, overlapping, or offset.

7. The modular fence of claim 1, wherein the vertical supports have a groove at least the length of the interior panels, and where the groove is sufficiently wide to allow the edge of the interior panels to enter the groove.

8. The modular fence of claim 1, wherein the vertical supports have a groove at least the length of the interior panels, and the groove extends the full length of said vertical support.

9. The modular fence of claim 1, wherein the thickness of the vertical supports is approximately the same as the thickness of the horizontal rails.

10. The modular fence of claim 1, wherein multiple panels of different widths are used to fill the space between the vertical supports.

11. The modular fence of claim 1, wherein the vertical supports, horizontal rails, interior panels, and fasteners are assembled prior to being received by the installer.

12. The modular fence of claim 1, wherein the vertical supports, horizontal rails, interior panels, and fasteners are shipped as an unassembled kit.

13. The modular fence of claim 1, wherein the vertical supports, horizontal rails, interior panel(s), and fasteners are assembled by placing the internal panels in position relative to the horizontal rails, utilizing the constraining features on the internal panels and the horizontal rails;
cutting the horizontal rails and internal panel(s) to size if necessary; and attaching the vertical supports to the horizontal rails and internal panel(s) with the fasteners.

14. The modular fence of claim 1, wherein brackets are used to further secure the panels to the posts.

15. The modular fence of claim 1, wherein the panels are secured to the outsides of the posts.

16. The modular fence of claim 1, wherein the panels are secured between the posts.

17. The modular fence of claim 1, wherein the panels further comprise hardware.

18. The modular fence of claim 1, wherein the posts further comprise an interior support component.

19. The modular fence of claim 1, wherein the posts further comprise a post component.

20. The modular fence of claim 19, wherein the vertical supports are secured to the post components and the post components are secured to the post.

21. The modular fence of claim 19, wherein the vertical supports are secured to the posts post and the post components are secured to the post.

22. The modular fence of claim 19, further comprising intermediate post components secured between the vertical supports and the post components, wherein the vertical supports are secured to the post components and the intermediate post components.

23. The modular fence of claim 1, further comprising front and back post components and the vertical supports are secured to both the front and back post components.

24. The modular fence of claim 19, wherein the horizontal rails are secured to the post component and the vertical supports are captured between grooves in the horizontal rails.

25. The modular fence of claim 23, wherein the horizontal rails are secured to the front and back post component and the vertical supports are captured between grooves in the horizontal rails.

26. A kit for assembling a modular fence, said kit comprising:
a. one or more horizontal rails;
b. one or more vertical supports;
c. one or more interior panels;
d. one or more fasteners;
e. one or more posts;
f. wherein said kit is assembled by placing the posts in the ground, placing the internal panels in position relative to the horizontal rails, utilizing the constraining features on the internal panels and the horizontal rails, cutting the horizontal rails and internal panel(s) to size if necessary, attaching the vertical supports to the horizontal rails and internal panel(s) with the fasteners, securing the panel(s) to the posts.
